(19) United States
(12) Patent Application Publication
(10) Pub. No.: US 2008/0243364 A1
(43) Pub. Date: Oct. 2, 2008

(54) Neural network-based engine misfire detection systems and methods

(75) Inventors: Pu Sun, Canton, MI (US); Kenneth Marko, Ann Arbor, MI (US)

Correspondence Address: MERCHANT & GOULD PC, P.O. BOX 2903, MINNEAPOLIS, MN, 55402-0903, US

(73) Assignees: ETAS, Inc., Ann Arbor, MI (US); Robert Bosch GmbH, Stuttgart (DE)

(21) Appl. No.: 11/728,419

(22) Filed: Mar. 26, 2007

(51) Int. Cl. G01M 15/11

(52) U.S. Cl. 701/111

(57) ABSTRACT

Methods and systems for detecting misfire events in a multicylinder engine are disclosed. One method includes associating a neural network with a cylinder of a multicylinder engine. The method also includes inputting to the neural network a plurality of crankshaft parameters. The method further includes determining the existence of an engine misfire in the cylinder based on the output of the neural network.

### TECHNICAL FIELD

The present disclosure relates to methods and systems for detection of misfire events within an engine. More specifically, the present disclosure relates to use of neural networks in detecting misfire events in multicylinder engines.

### BACKGROUND

In a typical combustion engine, fuel is ignited within a cylinder in the engine, forcing air within a cylinder to expand and forcing movement of a piston. The piston in turn pushes against a portion of a crankshaft, causing the shaft to rotate. If, for some reason, the fuel is not ignited, no force is exerted on the crankshaft. These occurrences, called “misfires”, relate to combustion failures within the engine, and adversely affect engine efficiency. In a vehicle engine, the loss in efficiency is reflected by the vehicle's emissions and fuel mileage.

Complex multicylinder engines, such as can be found in modern vehicles, are required to have diagnostic systems that continuously detect misfires in order to satisfy various emissions regulations, such as those set forth by the Environmental Protection Agency and the California Air Resources Board. These diagnostic systems are required to operate continuously and in all conditions in which the vehicle operates. Further, these systems must operate at a specific level of accuracy, with respect to both false alarms (detection of a misfire when no misfire actually occurred) or detection failures (no detection of a misfire which did occur). Various types of misfire detection schemes have been attempted, such as those which detect misfires based on changes in rotational velocity of the engine crankshaft. An exemplary misfire detection scheme is shown in U.S. Pat. No. 5,732,382, assigned to Ford Global Technologies, Inc. However, these systems suffers from a variety of drawbacks, most notably related to the accuracy of the systems, as related to the rate of occurrence of false alarms and detection failures.

Therefore, improvements are desired.

### SUMMARY

In accordance with the present disclosure, the above and other problems are solved by the following:

In a first aspect, a method of detecting misfire events in a multicylinder engine is disclosed. The method includes associating a neural network with a cylinder of a multicylinder engine. The method also includes inputting to the neural network a plurality of crankshaft parameters. The method further includes determining the existence of an engine misfire in the cylinder based on the output of the neural network.

In a second aspect, a misfire detector for use in an engine having a plurality of cylinders is disclosed. The misfire detector includes a memory configured to store a plurality of crankshaft parameters and a plurality of neural networks. The misfire detector also includes an input circuit configured to sense one or more parameters of a crankshaft of the engine. The misfire detector further includes a programmable circuit operatively connected to the memory and the input circuit. The programmable circuit is configured to execute program instructions to associate a neural network with a cylinder of a multicylinder engine. The programmable circuit is further programmed to input to the neural network a plurality of crankshaft parameters received from the input circuit. The programmable circuit is further programmed to determine the existence of an engine misfire in the cylinder based on the output of the neural network.

In a third aspect, a motor vehicle having a system for detecting engine misfires is disclosed. The motor vehicle includes an engine including a crankshaft and a plurality of cylinders. The motor vehicle also includes a misfire detector. The misfire detector includes a memory configured to store a plurality of crankshaft parameters and a plurality of neural networks. The misfire detector also includes an input circuit configured to sense one or more parameters of the crankshaft. The misfire detector further includes a programmable circuit operatively connected to the memory and the input circuit. The programmable circuit is configured to execute program instructions to associate a neural network with a cylinder of a multicylinder engine. The programmable circuit is also configured to execute program instructions to input to the neural network a plurality of crankshaft parameters received from the input circuit. The programmable circuit is also configured to execute program instructions to determine the existence of an engine misfire in the cylinder based on the output of the neural network.

### BRIEF DESCRIPTION OF THE DRAWINGS

FIG. 1 shows methods and systems for misfire detection according to a possible embodiment of the present disclosure;

FIG. 2 shows an exemplary environment for implementing various aspects of the present disclosure;

FIG. 3 shows a motor vehicle having a system for detecting engine misfires according to a possible embodiment of the present disclosure;

FIG. 4 shows a misfire detector interfaced with a crankshaft according to a possible embodiment of the present disclosure;

FIG. 5 shows a neural network for detecting a misfire in a cylinder of a motor vehicle according to a possible embodiment of the present disclosure;

FIG. 6 shows the logical design of methods and systems for misfire detection in a multicylinder engine according to various possible embodiments of the present disclosure;

FIG. 7 is a logical schematic diagram indicating correlation between a neural network and a crankshaft according to a possible embodiment of the present disclosure;

FIG. 8 is a logical schematic diagram indicating correlation between a neural network and a crankshaft according to a second possible embodiment of the present disclosure;

FIG. 9 is a logical schematic diagram indicating correlation between a neural network and a crankshaft according to a third possible embodiment of the present disclosure;

FIG. 10 shows methods and systems for misfire detection according to a further possible embodiment of the present disclosure; and

FIG. 11 displays exemplary misfire accuracy achievable through use of the disclosed systems and methods for misfire detection.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the invention described herein are implemented as: (1) a sequence of computer implemented steps, operations, or procedures running on a programmable circuit within a computer, (2) a sequence of computer implemented steps, operations, or procedures running on a programmable circuit within a motor vehicle or vehicle test system; and/or (3) interconnected machine modules or program engines within the programmable circuits.

In general the present disclosure relates to accurate detection of misfire events within an engine, such as an internal combustion engine. The detection of misfire events within the engine is based on crankshaft dynamics, through detection of various parameters of a crankshaft, such as the crankshaft rotational speed, acceleration, and angular position. Neural networks, such as a time-lagged recurrent neural network (TLRNN) are associated with each cylinder of the engine and detect misfire events from that cylinder. Historical crankshaft parameters, as well as the output of the previously-executing neural network, are provided to the neural network. The neural networks described herein are previously trained on a similar system so as to detect specific instances in which a misfire is likely or unlikely based on observance of previously-occurring situations. Various methods of training the neural networks are possible.

The methods and systems disclosed herein provide improved performance over previously known methods, as measured by false alarm rate and missed detection error rates. The methods and systems accomplish this improvement through improved compensation for torsional oscillations experienced by the crankshaft based on rotating unbalanced masses along the crankshaft's rotational axis.

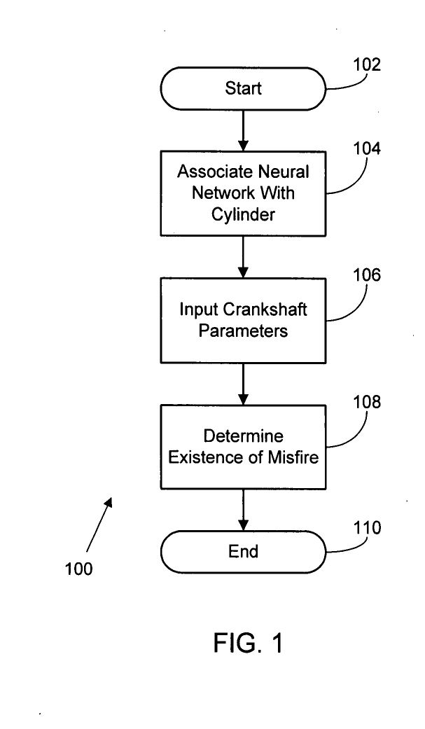

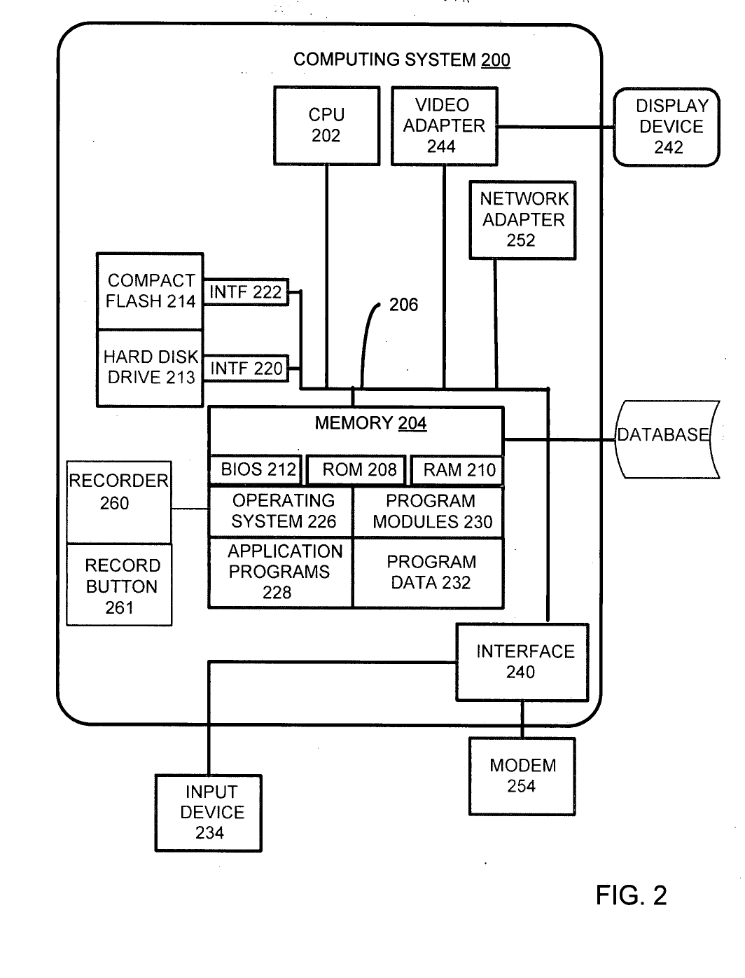

Referring now to FIG. 1, methods and systems for misfire detection are shown according to a possible embodiment of the present disclosure. The system 100 is configured to detect a misfire on a cylinder of a multicylinder engine. By using multiple of the system 100 or executing the system more than once, misfire events on more than one cylinder can be detected. The system 100 can be implemented in any computerized system, such as an embedded computing module or other computing system. An exemplary computing system is described below in conjunction with FIG. 2.

The system 100 is instantiated at a start operation 102. The start operation 102 corresponds to initialization of a misfire detection system, which may occur when a car is started or when the system is triggered by an external controller.

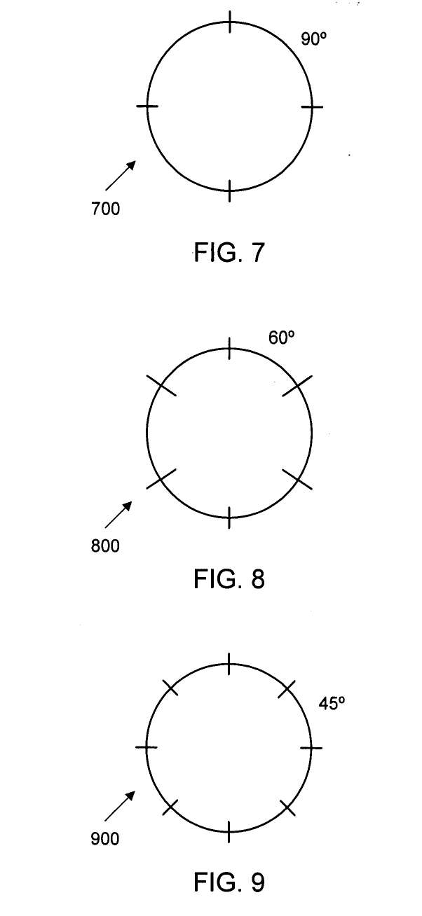

Operational flow proceeds to an association module 104. The association module 102 associates a neural network with a cylinder in a multicylinder engine. In one embodiment, the neural network is a time-lagged recurrent neural network that is trained using the same cylinder as that with which it is associated. In various embodiments, the association module 102 associates the neural network with a cylinder by providing inputs to the neural network measured at the crankshaft only when the crankshaft is in a predetermined angular position at which it is expected that the cylinder should fire. Illustrative systems for associating the neural network with a cylinder are discussed in conjunction with FIGS. 7-9.

Operational flow proceeds to an input module 106. The input module 106 inputs crankshaft parameters into the neural network to allow the neural network to determine the likely existence of a misfire event. Various crankshaft parameters may be input into the neural network, including the angular velocity of the crankshaft, the acceleration of the crankshaft, the squared velocity of the crankshaft, and the output of the previously executing neural network. Additional crankshaft parameters can be input to the neural network as well.

Operational flow proceeds to a misfire determination module 108. The misfire determination module 108 corresponds to operation of the neural network to determine, based on the inputs received by the input module 106, the existence or absence of a misfire in the cylinder associated with the neural network. Operational flow terminates at an end operation 110.

Referring now to FIG. 2, an exemplary environment for implementing embodiments of the present disclosure includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

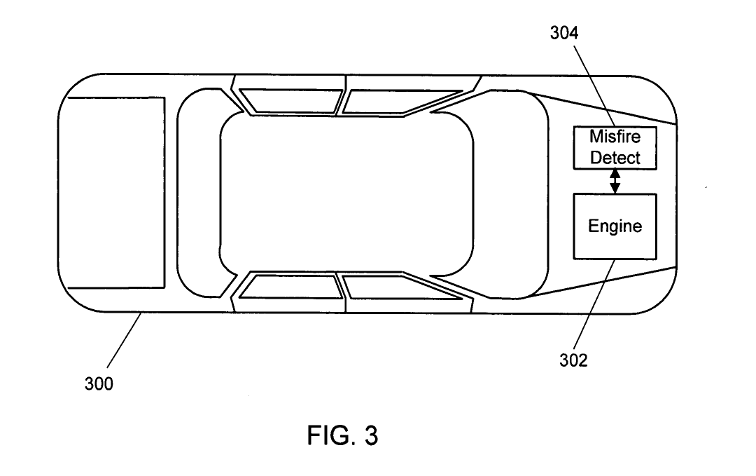

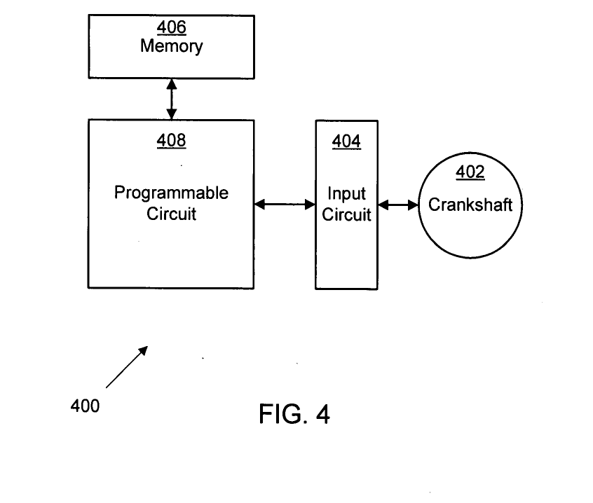

Referring now to FIG. 3, a schematic view of a vehicle 300 is shown. The vehicle 300 includes an engine 302, which is interfaced to a misfire detection system 304. The engine 302 is a multicylinder internal combustion engine, including a crankshaft. The misfire detection system 304 interfaces with the engine at the crankshaft. The misfire detection system 304 is configured to operate concurrently with the engine 302, monitoring misfires by measuring and analyzing various crankshaft parameters. An example misfire detection system is described in conjunction with FIG. 4.

FIG. 4 shows a schematic block diagram of a misfire detection system 400 interfaced with a crankshaft 402 according to a possible embodiment of the present disclosure. The misfire detection system 400 includes an input circuit 404, a memory 406, and a programmable circuit 408. The input circuit 404 interfaces with the crankshaft, and includes circuitry for sensing rotation of the crankshaft, from which a variety of crankshaft parameters can be derived, including the angular position, rotational speed, and acceleration of the crankshaft. Additional parameters may be derived as well.

The memory 406 is any of a number of types of volatile or non-volatile memories, and is configured to store a variety of data required for operation of the misfire detection system 400. This data can include training data used to train one or more neural networks, the operation and structure of the neural networks, stored data received from the input circuit 404, information about the monitored engine, and other data. In some embodiments, program instructions for the programmable circuit 408 are stored in an instruction memory portion of the memory 406, which may or may not by physically or logically separate from the memory used for storage of the data values.

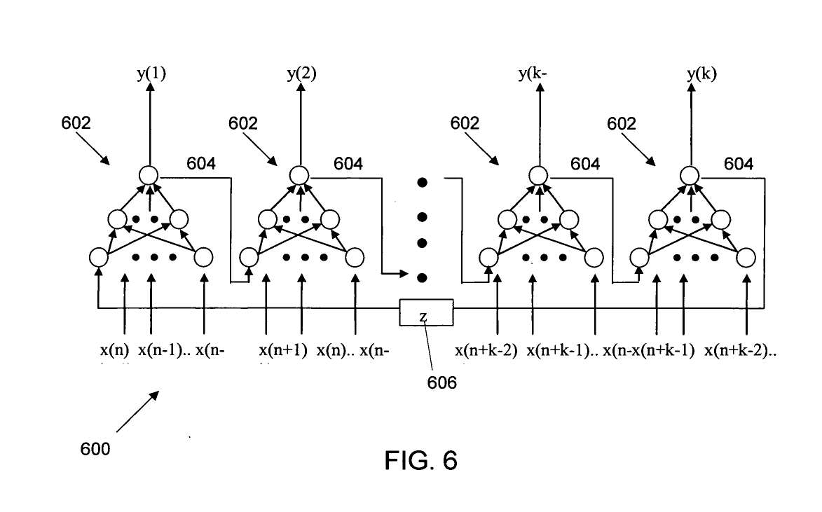

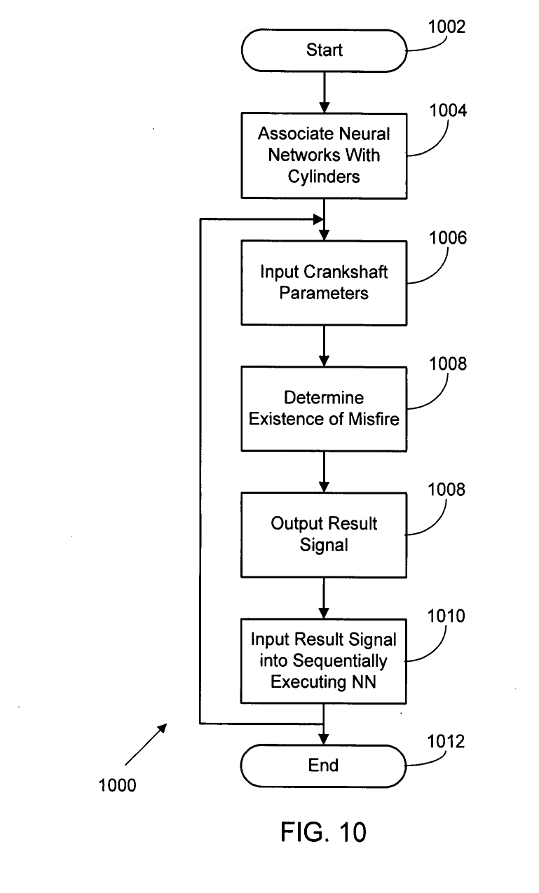

The programmable circuit 408 is operatively connected to the input circuit 404 and the memory 406, and executes a variety of tasks related to the misfire detection system 400. The programmable circuit can be programmed to execute various methods for misfire detection using neural networks, such as those methods shown in FIGS. 1 and 10. One specific implementation using neural networks is seen in FIG. 6.

In one embodiment, the programmable circuit 408 is a component of a computing system, such as the system shown in FIG. 2. In a further embodiment, the programmable circuit 408 a microcontroller. The microcontroller is programmable in any of a number of programming languages, such as assembly language, C, or other low-level language. In alternate embodiments, the programmable circuit 408 is a programmable logic device (PLD) such as a field programmable gate array (FPGA), Complex Programmable Logic Device (CPLD), or Power ASIC (Application Specific Integrated Circuit). In these embodiments, a hardware description language such as Verilog, ABEL, or VHDL defines operation of the programmable circuit 408. In an embodiment in which the programmable circuit 408 is a microcontroller, multiple programmable circuits are implementable within a single microcontroller, if desired, by implementing a time-sharing scheduling system in which each programmable circuit operates at an effective frequency determined by the frequency of the microcontroller and the number of programmable circuits required.

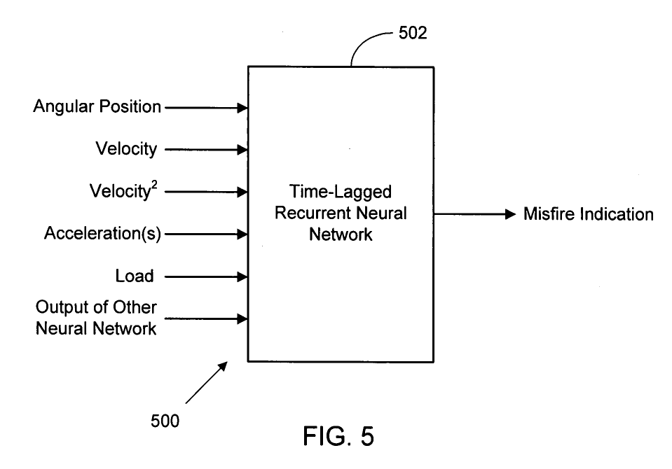

Referring now to FIG. 5, a neural network 500 is shown for detecting a misfire in a cylinder of a motor vehicle according to a possible embodiment of the present disclosure. In the embodiment shown, the neural network 500 is a time-lagged recurrent neural network (TLRNN). The neural network receives a plurality of inputs related to factors leading to misfire events, and at least one output signal representing detection or non-detection of a misfire event by the neural network 500.

The plurality of inputs include a number of crankshaft parameters, which may be either received from an input circuit or calculated prior to input to the neural network 500, such as shown above in FIG. 4. These crankshaft parameters include the angular position of the crankshaft, the rotational velocity of the crankshaft, the rotational acceleration of the crankshaft, the square of the rotational velocity of the crankshaft, the load applied to the crankshaft, and other parameters. Additionally, the output of a separate neural network executing immediately preceding execution of the neural network 500 is input into the currently executing neural network, as exemplified in the multiple neural network system of FIG. 6. Other parameters may be input to the neural network as well.

Referring now to FIG. 6, the logical design of methods and systems for misfire detection in a multicylinder engine are shown according to various possible embodiments of the present disclosure. The system 600 represents a generalized system for a multicylinder engine having k cylinders. The system 600 includes a plurality of neural networks 602, which may be time-lagged recurrent neural networks, such as the one shown in FIG. 5. Each of the neural networks 602 are shown to have a plurality of inputs 604, signified by the notation x(n), x(n-1), etc. These inputs 604 correspond to the crankshaft acceleration values for the appropriate intervals between cylinder firings, as described in FIGS. 7-9, below. The crankshaft acceleration values can be detected, using an input circuit such as the one shown in FIG. 4, or can be derived from time and rotational position information of the crankshaft, such as by using a programmable circuit. Additional inputs, such as those described above in conjunction with FIG. 5, are possible as well.

In the embodiment shown, each neural network 602 receives inputs related to the accelerations in the other of the cylinders in the engine. For example, in a 10 cylinder engine, each neural network will have inputs of accelerations in the last 9 cylinder firing events, and the acceleration for the current cylinder firing event. Hence, for a k cylinder engine, a sliding window of k acceleration inputs is provided to each neural network when that network executes.

Sequential control and timing of execution of the neural networks 602 is controlled by the rotational position of the crankshaft of the engine being monitored. As the crankshaft rotates through a plurality of angles, expected cylinder firing events of each cylinder correspond to specific angular positions of the crankshaft. The neural network associated with that cylinder executes substantially concurrently to determine whether a misfire occurred for that cylinder firing event.

Recursive inputs 604 received by each neural network 602 correspond to the output of the previously-executing neural network. This recursive input 604 provides explicit knowledge to the currently executing neural network 602 of the existence of a misfire event occurring in the cylinder expected to fire immediately before the cylinder being monitored by the current neural network.

An optional delay module 606 executes after a complete engine cycle has run, with each of the cylinders firing once. The delay module 606 prevents the system 600 from executing continuously.

Referring now to FIG. 7-9, logical schematic diagrams indicating correlation between a neural network and a crankshaft are shown according to various possible embodiments of the present disclosure. FIG. 7 corresponds to correlation of four neural networks to the cylinders of a four cylinder engine. In a four cylinder engine, a cylinder fires for every 90 degrees of rotation of the crankshaft. Therefore, the misfire detection systems described herein must detect a firing event (or a corresponding misfire) four times per crankshaft rotation, at every 90 degrees. To accomplish this, each of four neural networks is associated with a unique cylinder and therefore a corresponding rotational position of the crankshaft. Each neural network determines the existence of a misfire for that cylinder, with each neural network executing once in succession during each crankshaft rotation.

Similarly, FIG. 8 corresponds to correlation of six neural networks to the cylinders of a six cylinder engine, with one of the six cylinders firing for every 60 degrees of crankshaft rotation. FIG. 9 corresponds to correlation of eight neural networks to the cylinders of an eight cylinder engine, with one of the eight cylinders firing for every 45 degrees of crankshaft rotation. Additional correlations of more or fewer neural networks can be used in combination with engines having more or fewer cylinders. In one possible embodiment, a single neural network monitors misfire events of two cylinders, or some other number of cylinders. In other embodiments, multiple neural networks are trained and correspond to the same cylinder.

Referring now to FIG. 10, methods and systems for misfire detection are shown according to a possible embodiment of the present disclosure. The system 1000 disclosed can be used in conjunction with a logical design for misfire detection in a multicylinder engine such as is shown in FIG. 6. The system 1000 instantiates at a start operation 1002, which corresponds to starting a multicylinder engine which is to be monitored for misfire occurrences.

Operational flow proceeds to an association module 1004. The association module 1004 associates a plurality of neural networks with the plurality of cylinders in the multicylinder engine to be monitored for misfire events. The association module can, for example, assign a neural network for one of a plurality of angular positions of the engine crankshaft as described above in conjunction with FIGS. 7-9.

In one embodiment, the association module 1004 also corresponds to training the various neural networks used in the misfire detection system 1000. Various training methods can be employed by the association module. Exemplary training methods for training neural networks, in particular time lagged recurrent neural networks (TLRNN) are discussed in detail in the following publications, which are hereby incorporated by reference in their entirety: Optimal Learning Rate for Training Time Lagged Recurrent Neural Networks with the Extended Kalman Filter Algorithm, Pu Sun and Kenneth Marko, IEEE Conference on Neural Networks, Anchorage, Ak., May, 1998; The Square Root Kalman Filter Training of Recurrent Neural Networks, Pu Sun and Kenneth Marko, IEEE Conference on Systems, Man and Cybernetics, San Diego, Calif., October, 1998; Training Recurrent Neural Networks for Very High Performance with the Extended Kalman Algorithm, Kenneth Marko and Pu Sun, ANNIE 98 Conference, St. Louis, Mo., November 1998. In a further embodiment, the neural networks are trained prior to association with the vehicle, such as by training on a related engine separate from the one monitored using the techniques described in the above-cited references.

Operational flow proceeds to an input module 1006. The input module 1006 corresponds to the input module 106 of FIG. 1, and provides a plurality of inputs to the current neural network, i.e. the neural network associated with the most-recently-firing cylinder of the engine. The inputs include various crankshaft parameters input into the neural network, including the angular velocity of the crankshaft, the acceleration of the crankshaft, the squared velocity of the crankshaft, and the output of the previously executing neural network. Additional crankshaft parameters can be input to the neural network as well.

Operational flow proceeds to a determination module 1008. The determination module 1008 corresponds to the determination module 108 of FIG. 1. The determination module 1008 corresponds to operation of the neural network to determine, based on the inputs received by the input module 1006, the existence or absence of a misfire in the cylinder associated with the neural network.

Operational flow proceeds to an output module 1010. The output module 1010 generates an output signal in the current neural network representing the presence or absence of a misfire in the cylinder associated with that neural network.

Operational flow proceeds to a feedback module 1012. The feedback module transfers control to the next neural network, that is, the neural network associated with the next-firing cylinder in the engine. The feedback module provides the output signal from the output module 1010 to the next neural network (the output signal referred to as the output of the “previously executing neural network” in the input module 1006, above). Operational flow proceeds to the input module 1006, by which the modules 1006-1012 are executed sequentially to cycle through all of the neural networks in the system 1000 during operation of the engine, so that each time a specific cylinder fires, a dedicated neural network is used to detect a misfire. Operational flow terminates at an end operation 1014, which corresponds to stoppage of the engine and/or the misfire detector.

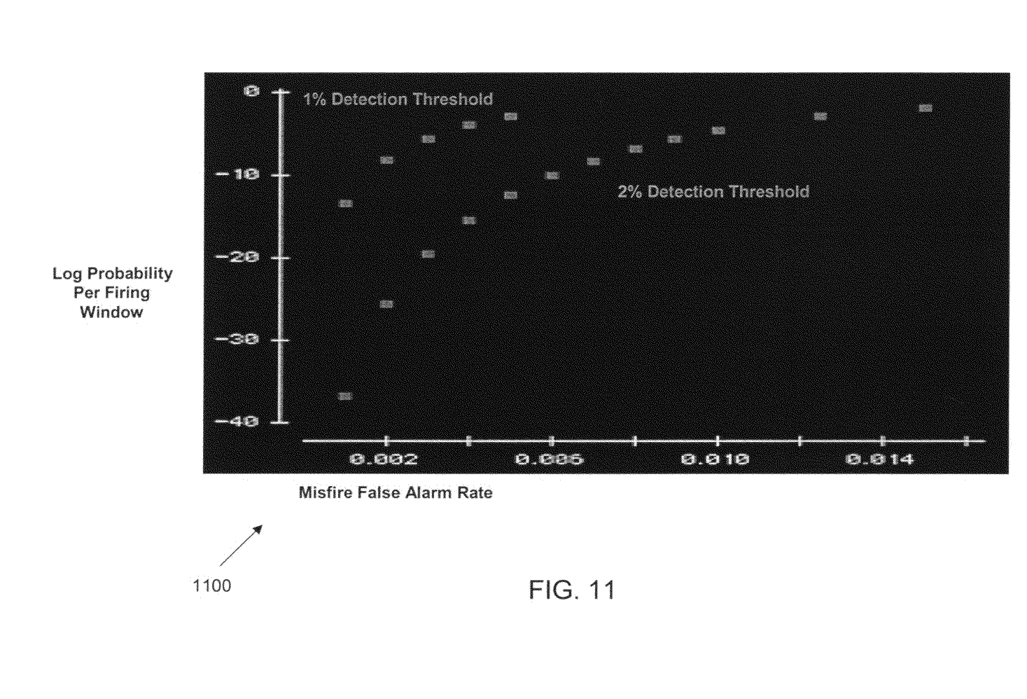

FIG. 11 displays a chart 1100 illustrating exemplary misfire accuracy achievable through use of the disclosed systems and methods for misfire detection. The chart 1100 illustrates the correlation between the rate of false alarm events and the rate of alpha events, or missed misfire events. As illustrated, false alarms can be nearly eliminated by even a small reduction in the misfire false alarm rate. For example, at a misfire false alarm rate (MFAR) of 0.4%, the probability of a false alarm in the firing window is about 10⁻⁵. Assuming about 100,000 time windows of observation per vehicle lifetime, the probability of a false alarm is then about 1 in a vehicle lifetime at a 1% detection threshold, assuming the MFAR of 0.4%. If the MFAR is decreased by a factor of two to 0.2%, the probability of a false alarm drops by three orders or magnitude, to a factor of greater than 10⁻¹⁰, rendering the probability negligible for the purposes of the diagnostic systems described herein.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of detecting misfire events in a multicylinder engine, the method comprising:
associating a neural network with a cylinder of a multicylinder engine;
inputting to the neural network a plurality of crankshaft parameters;
determining the existence of an engine misfire in the cylinder based on the output of the neural network.

2. The method of claim 1, wherein the plurality of crankshaft parameters include a plurality of crankshaft acceleration values.

3. The method of claim 2, wherein the plurality of crankshaft acceleration values includes crankshaft acceleration values caused by the remaining cylinders of the multicylinder engine.

4. The method of claim 1, wherein associating the neural network with a cylinder comprises associating the neural network with a rotational position of a crankshaft of the engine.

5. The method of claim 1, further comprising outputting a result signal representing a detected engine misfire.

6. The method of claim 5, further comprising inputting the result signal to a second neural network associated with a second cylinder of the multicylinder engine.

7. The method of claim 1, further comprising inputting to the neural network a rotational speed of the crankshaft.

8. The method of claim 1, further comprising inputting to the neural network a squared value of a rotational speed of the crankshaft.

9. The method of claim 1, further comprising inputting to the neural network a current rotational acceleration value of the crankshaft.

10. The method of claim 1, wherein the neural network is a time-lagged recurrent neural network.

11. A misfire detector for use in an engine having a plurality of cylinders, the misfire detector comprising:
a memory configured to store a plurality of crankshaft parameters and a plurality of neural networks;
an input circuit configured to sense one or more parameters of a crankshaft of the engine;
a programmable circuit operatively connected to the memory and the input circuit, the programmable circuit configured to execute program instructions to:
associate a neural network with a cylinder of a multicylinder engine;
input to the neural network a plurality of crankshaft parameters received from the input circuit; and
determine the existence of an engine misfire in the cylinder based on the output of the neural network.

12. The misfire detector of claim 11, wherein the plurality of crankshaft parameters include a plurality of crankshaft acceleration values.

13. The misfire detector of claim 12, wherein the plurality of crankshaft acceleration values includes crankshaft acceleration values caused by the remaining cylinders of the multicylinder engine.

14. The misfire detector of claim 11, wherein the programmable circuit is further programmed to associate the neural network with a rotational position of a crankshaft of the engine.

15. The misfire detector of claim 11, wherein the programmable circuit is further programmed to output a result signal representing a detected engine misfire.

16. The misfire detector of claim 15, wherein the programmable circuit is further programmed to input the result signal to a second neural network associated with a second cylinder of the multicylinder engine.

17. A motor vehicle having a system for detecting engine misfires, the motor vehicle comprising:
an engine including a crankshaft and a plurality of cylinders;
a misfire detector comprising:
a memory configured to store a plurality of crankshaft parameters and a plurality of neural networks;
an input circuit configured to sense one or more parameters of the crankshaft;
a programmable circuit operatively connected to the memory and the input circuit, the programmable circuit configured to execute program instructions to:
associate a neural network with a cylinder of a multicylinder engine;
input to the neural network a plurality of crankshaft parameters received from the input circuit; and
determine the existence of an engine misfire in the cylinder based on the output of the neural network.

18. The motor vehicle of claim 18, wherein the programmable circuit is further programmed to output a result signal representing a detected engine misfire.

19. The motor vehicle of claim 19, wherein the programmable circuit is further programmed to input the result signal to a second neural network associated with a second cylinder of the multicylinder engine.
